(19) United States
(12) Patent Application Publication
(10) Pub. No.: US 2024/0204276 A1
(43) Pub. Date: Jun. 20, 2024

(54) EUTECTIC SYNTHESIS FOR UPCYCLING OF CATHODE MATERIALS

(71) Applicant: UT-Battelle, LLC, Oak Ridge, TN (US)

(72) Inventors: Jianlin Li, Oak Ridge, TN (US); Mengya Li, Oak Ridge, TN (US); William B. Hawley, Oak Ridge, TN (US)

(21) Appl. No.: 18/536,523

(22) Filed: Dec. 12, 2023

Related U.S. Application Data
(60) Provisional application No. 63/432,720, filed on Dec. 15, 2022.

(51) Int. Cl. H01M 10/54; C01G 53/00; H01M 10/0525

(52) U.S. Cl. CPC H01M 10/54; C01G 53/42; H01M 10/0525; C01P 2002/72; C01P 2004/03; C01P 2004/04; C01P 2006/40

(57) ABSTRACT

A method of upcycling cathode active materials is provided. The method includes mixing two or more precursor materials at ambient temperature to form a first eutectic mixture. The method further includes mixing a cathode active material with the first eutectic mixture to form a second eutectic mixture. The method further includes subjecting the second eutectic mixture to a two-step calcination process. The two-step calcination process includes first calcining the second eutectic mixture at a first temperature for a first period of time to obtain an intermediate material and second, calcining the intermediate material at a second temperature for a second period of time to obtain an upcycled cathode active material. The second temperature is higher than the first temperature, and the upcycled cathode active material has a composition that is different than a composition of the cathode active material. A cathode active material formed by the method is also provided.

### CROSS-REFERENCE TO RELATED APPLICATIONS

This application claims the benefit of U.S. Provisional Application No. 63/432,720, filed Dec. 15, 2022, the disclosure of which is incorporated by reference in its entirety.

### STATEMENT REGARDING FEDERALLY SPONSORED RESEARCH AND DEVELOPMENT

This invention was made with government support under Contract No. DE-AC05-000R22725 awarded by the U.S. Department of Energy. The government has certain rights in the invention.

### FIELD OF THE INVENTION

The present invention relates to upcycling of cathode materials, and more particularly to a eutectic synthesis method for upcycling cathode materials.

### BACKGROUND OF THE INVENTION

The high energy density and long lifespan of lithium-ion batteries (LIBs) has made them the primary source of power for portable electronic devices and electric vehicles (EVs). The proliferation of portable electronic devices and increasing presence of EVs has therefore raised the need for lithium-ion batteries. The ever-expanding lithium-ion battery (LIB) market requires growth in LIB production capacity. However, increased LIB production requires additional consumption of critical rare, expensive metals, and greater production and use of LIBs also generates an enormous number of end-of-life (spent) LIBs. Thus, there is growing interest and effort in developing organic cathode materials or new electrode materials with low Co content, as well as recycling of materials from spent batteries. Particular efforts have been made to recycle valuable elements and compounds from spent batteries. Meanwhile, the continuous demand for longer driving range in EVs has motivated material development and cell engineering to increase energy density. For instance, low Ni content LiNiₓMn_{y}Co_{1-x-y}O₂(NMC) (i.e., NMC111 and NMC532) was a typical cathode material used in early generation EV batteries. However, high Ni content NMC (x≥0.6) is now the state-of-the-art cathode material for high energy density applications and has been adopted in recent EV batteries. Compared to NMC111, NMC811 poses a higher energy density and higher specific capacity of 190 mAh·g⁻¹ (at room temperature and C/10 discharge rate for industrially-relevant active mass loadings). When the original generation of electric vehicle batteries using low Ni content NMC materials reach their end-of-life (EOL), it would be advantageous to not only recycle these cathode materials, but also “upcycle” the obsolete formulation into state-of-art materials such as NMC811.

Obsolete LIB cathode formulations like NMC111 can be upgraded either through resynthesis using salts recovered from a hydrometallurgical process or a direct upcycling method. Hydrometallurgical processes disadvantageously require the use of corrosive acid and energy intensive calcination steps, leaving a larger carbon footprint. Methods of upcycling cathode materials including solid-state sintering, hydrothermal processes, and the use of deep eutectic solvents. Solid-state sintering is easy in operation but has challenges in homogeneity and slow ion diffusion in the solid phase. Thus, solid-state sintering requires higher temperatures and longer sintering times. Hydrothermal methods allow for homogenous mixing of precursors but typically require multiple steps in rinsing and sintering under high pressure (i.e., in autoclaves). Deep eutectic solvents are formed from a eutectic mixture of Lewis or Bronsted acids and bases, which has a low melting point owing to the charge delocalization through hydrogen bonding. This can improve the homogeneity in the synthesized product and reduce the sintering temperature. However, the solvents are expensive. In addition, a “reciprocal ternary molten salts” system has been developed to directly upcycle spent NMC111 to NMC622 by simultaneously realizing the addition of Ni and the relithiation of Li in spent NMC111. However, this process utilizes molten salts as flux media, which potentially increases the processing cost. Therefore, it is important to develop a simple yet effective, and energy-efficient process to upgrade cathode chemical composition.

### SUMMARY OF THE INVENTION

An improved method of upcycling cathode active materials, such as, for example, NMC111 to NMC811, via eutectic synthesis is provided. The method allows for the formation of a eutectic solution at room temperature, thereby reducing energy consumption in the upcycling process. A eutectic solution also provides for improved composition homogeneity. More particularly, the method includes mixing two or more precursor materials at ambient temperature to form a first eutectic mixture. The method further includes mixing a cathode active material with the first eutectic mixture to form a second eutectic mixture. The method further includes subjecting the second eutectic mixture to a two-step calcination process. The two-step calcination process includes first calcining the second eutectic mixture at a first temperature for a first period of time to obtain an intermediate material and second, calcining the intermediate material at a second temperature for a second period of time to obtain an upcycled cathode active material. The second temperature is higher than the first temperature, and the upcycled cathode active material has a composition that is different than a composition of the cathode active material.

In specific embodiments, the first temperature is in a range of 300 to 400° C.

In specific embodiments, the second temperature is in a range of 700 to 1000° C.

In specific embodiments, the first period of time is at least 4 hours.

In specific embodiments, the second period of time is at least 8 hours.

In specific embodiments, the two-step calcination process further includes an intermediate step of muddling the second eutectic mixture after the first calcining and before the second calcining.

In specific embodiments, the first calcining is performed in ambient air.

In specific embodiments, the second calcining is performed in the presence of an oxygen (02) stream.

In specific embodiments, the precursor materials include lithium hydroxide and nickel nitrate.

In specific embodiments, the method further includes the step of sieving the upcycled cathode active material after the second calcining.

In specific embodiments, the cathode active material is obtained from one of or both of a spent battery and cathode scrap from a cathode manufacturing process.

In specific embodiments, the cathode active material comprises a lithium-bearing metal oxide.

In specific embodiments, the upcycled cathode active material has a nickel content that is greater than a nickel content of the cathode active material.

In specific embodiments, the upcycled cathode active material: (i) comprises substantially the same morphology as the cathode active material; (ii) is directly reusable in the preparation of a new composite electrode; or (iii) both (i) and (ii).

In specific embodiments, the method further includes preparing a new composite electrode using the upcycled cathode active material.

In particular embodiments, the method further includes preparing a new lithium-ion battery using the new composite electrode.

A cathode active material formed by the method is also provided.

These and other features of the invention will be more fully understood and appreciated by reference to the description of the embodiments and the drawings.

### BRIEF DESCRIPTION OF THE DRAWINGS

FIG. 1 is a graph of XRD patterns of CA-NMC111 (commercially available NMC111), CA-NMC811 (commercially available NMC811), and ES-NMC811 (NMC811 formed by the method);

FIG. 2A is a SEM image of the CA-NMC111;

FIG. 2B is an enlarged SEM image of the CA-NMC111;

FIG. 2C is a SEM image of the ES-NMC811;

FIG. 2D is an enlarged SEM image of the ES-NMC811;

FIG. 3A is a TEM image of the CA-NMC811;

FIG. 3B is a TEM image of the ES-NMC811;

FIG. 4 is a graph of the discharge capacity for 50 cycles of half cells made with the CA-NMC111, the CA-NMC811, and the ES-NMC811;

FIG. 5 is a graph of the coulombic efficiency for 50 cycles of half cells made with the CA-NMC111, the CA-NMC811, and the ES-NMC811;

FIG. 6 is a graph of charge and discharge curves for the 1^{st} and 50^{th} cycles of half cells made with the CA-NMC811 and the ES-NMC811; and

FIG. 7 is a graph of GITT data for the ES-NMC811.

### DETAILED DESCRIPTION OF THE CURRENT EMBODIMENTS

As discussed herein, the current embodiments relate to a method of upcycling cathode active materials. As used herein, “upcycling” refers to the recycling of cathode active materials (such as recycling cathode materials from lithium-ion batteries) while also converting the recycled cathode materials into updated, improved cathode materials that are closer to the state-of-the-art than the original recycled material (e.g., recycling NMC111 and converting it to NMC811). An upcycled cathode material would generally have more desirable performance characteristics than the original recycled material. The method generally includes mixing precursor materials and recycled cathode active materials to form a eutectic mixture, and subsequently subjecting the second eutectic mixture to a two-step calcination process. The method enables faster, less expensive upcycling of Ni-deficient materials than the conventional synthesis techniques. Each step is separately discussed below.

The method first includes mixing two or more precursor materials at ambient temperature (approximately 25° C., alternatively in the range of approximately 20 to 25° C.) to form a first eutectic mixture. The precursors may include, but are not limited to, lithium hydroxide (LiOH), lithium carbonate (Li₂CO₃), and nickel nitrate (Ni(NO₃)₂) or any hydrate thereof. Other lithium precursors may include by way of example lithium acetate (C₂H₃LiO₂), lithium nitrate (LiNO₃), lithium chloride (LiCl), or lithium bromide (LiBr). Other nickel precursors may include by way of example nickel sulfate (NiSO₄). Further, depending on the final desired stoichiometry of the upcycled material, cobalt (Co)- or manganese (Mn)-containing nitrates may be included as precursors. It should be understood that the elements contained in the precursors depend on the composition of the starting cathode material (see below) and the desired composition of the upcycled material. The mixing of the precursors may be performed, for example, in a mortar using a pestle. However, other means of mixing may be utilized, such as but not limited to mechanical ball-milling.

The method next includes mixing a cathode active material with the first eutectic mixture to form a second eutectic mixture. The cathode active material is not particularly limited in composition. In some embodiments, the cathode active material comprises a lithium-bearing metal oxide. Examples of such compounds include LiCoO₂, LiMn₂O₄, LiNiO₂, LiCrO₂, LiFePO₄, LiNiO₂, LiMn₂O₄, LiV₂O₅, LiTiS₂, LiMoS₂, LiMnO₂, LiFe_{1-z}M_{y}PO₄, as well as variations of lithium nickel oxides, lithium nickel manganese oxides, lithium nickel manganese cobalt oxides, and the like, exemplified by those having general formulas such as LiNiₓMn_{y}O₂, Li_{1+z}NiₓMn_{y}Co_{1-x-y}O₂, LiNiₓCo_{y}Al_{z}O₂, LiNiₓCo_{y}Mn_{z}O₂, etc., where each x, y, and z is typically a mole fraction of from 0 to 1, where x+y+z=1. Such materials are known in the art. The cathode active material may also comprise a conductive agent, e.g. for enhancing the electron conductivity of the cathode active material. Preferably, the cathode active material is obtained from one of or both of a spent battery and cathode scrap from a cathode manufacturing process, i.e. the cathode active material is recycled cathode active material. In one exemplary embodiment, the cathode active material is recycled NMC111 obtained from spent lithium-ion batteries that include NMC111. The cathode active material may therefore have spherical morphology. The mixing of the precursors may be performed, for example, in a mortar using a pestle, and may be performed in the same mortar/vessel in which the first eutectic mixture is formed by adding the cathode active material to the first mixture. However, other means of mixing may be utilized, such as mechanical ball-milling. The relative amounts of the precursors used in the first mixture is calculated based on the beginning amount of the cathode active material (e.g., NMC111) and the stoichiometric ratio of the final desired product (e.g., NMC811 wherein the stoichiometric ratio of Ni:Mn:Co is 8:1:1).

Subsequent to forming the second eutectic mixture, the method includes subjecting the second eutectic mixture to a two-step calcination process. The two-step calcination process first includes calcining the second eutectic mixture at a first temperature for a first period of time to obtain an intermediate material. The first temperature may be in a range of 300 to 400° C., optionally in a range of 310 to 400° C., optionally in a range of 320 to 400° C., optionally in a range of 330 to 400° C., optionally in a range of 340 to 400° C., optionally in a range of 350 to 400° C., optionally in a range of 360 to 400° C., optionally in a range of 370 to 400° C., optionally in a range of 380 to 400° C., optionally in a range of 390 to 400° C., optionally in a range of 300 to 390° C., optionally in a range of 300 to 380° C., optionally in a range of 300 to 370° C., optionally in a range of 300 to 360° C., optionally in a range of 300 to 350° C., optionally in a range of 300 to 340° C., optionally in a range of 300 to 330° C., optionally in a range of 300 to 320° C., optionally in a range of 300 to 310° C. The ramp rate (in ° C./min) for calcination at the first temperature may be 3.0, alternatively in the range of 2.0 to 5.0. The first period of time may be at least 4 hours, optionally at least 5 hours, optionally at least 6 hours, optionally in a range of 4 to 6 hours, optionally in a range of 4 to 5 hours, optionally in a range of 5 to 6 hours. In some embodiments, the first calcining may be performed in ambient air. The two-step calcination process also includes calcining the intermediate material at a second temperature for a second period of time to obtain an upcycled cathode active material having a composition that is different than a composition of the original cathode active material that was added to the first eutectic mixture. For example, the upcycled cathode active material may have a nickel content that is greater than the nickel content of the original cathode active material, e.g. the upcycled cathode active material may be NMC811. The second temperature is higher than the first temperature and may be in a range of 700 to 1000° C., optionally in a range of 750 to 1000° C., optionally in a range of 800 to 1000° C., optionally in a range of 850 to 1000° C., optionally in a range of 900 to 1000° C., optionally in a range of 950 to 1000° C., optionally in a range of 700 to 950° C., optionally in a range of 700 to 900° C., optionally in a range of 700 to 850° C., optionally in a range of 700 to 800° C., optionally in a range of 700 to 750° C., optionally in a range of 750 to 850° C., optionally in a range of 800 to 850° C., optionally in a range of 850 to 950° C., optionally in a range of 850 to 900° C. The ramp rate (in ° C./min) for calcination at the second temperature may be 3.0, alternatively in the range of 2.0 to 5.0. The second period of time may be at least 8 hours, optionally at least 9 hours, optionally at least 10 hours, optionally at least 11 hours, optionally at least 12 hours, optionally in a range of 8 to 12 hours, optionally in a range of 9 to 12 hours, optionally in a range of 10 to 12 hours, optionally in a range of 11 to 12 hours, optionally in a range of 8 to 11 hours, optionally in a range of 8 to 10 hours, optionally in a range of 8 to 9 hours. In some embodiments, the second calcining may be performed in the presence of an oxygen (O₂) stream.

The method may further include an optional intermediate step of muddling the second eutectic mixture after the first calcining and before the second calcining. The muddling may also be performed in the mortar with the pestle.

After the second calcining of the two-step calcination process, the obtained upcycled cathode active material may be sieved through a mesh such as but not limited to a 50 μm mesh to obtain a desired particle size.

The obtained upcycled cathode active material can have the same morphology as the original, starting cathode active material. Hence, the upcycled cathode active material may also have spherical morphology. The upcycled cathode active material may also be directly reusable to prepare a new composite electrode that can be used as the cathode for a new lithium-ion battery. As such, upcycling of the cathode active material from a spent battery or battery scrap can result in the formation of a new battery having improved performance in comparison to the original, spent battery.

### EXAMPLE

The present method is further described in connection with the following laboratory example, which is intended to be non-limiting.

The precursors used for the eutectic synthesis were LiOH·H₂O (Sigma Aldrich) and Ni(NO₃)₂·6H₂O (Sigma Aldrich). Pristine NMC111 (Targray, d₅₀=6.5 μm) was used as the cathode active material in lieu of end-of-life (EOL) NMC111 as none was readily available for testing. In the first step, appropriate amounts of LiOH·H₂O and Ni(NO₃)₂·6H₂O were added to a mortar and combined using a pestle. After several minutes of muddling, the mixture became a low-viscosity green slurry. Next, NMC111 was added and mixed further with the pestle. Initially, the mixture was a low-viscosity black slurry, but after a few minutes of stirring, became a more viscous slurry. This slurry was calcined at 400° C. for 6 hours (2.5° C.·min⁻¹) in ambient air to remove the nitrates from the slurry. Once finished, the product became gravel-like particles that were muddled with the mortar and pestle. These muddled powders were sintered again at 850° C. for 12 hours (2.5° C. min⁻¹) in flowing O₂ (1.0 SLM). The total reaction is written in the following Equation 1:

$${LiNi}_{\frac{1}{3}} {Mn}_{\frac{1}{3}} {Co}_{\frac{1}{3}} {O}_{2} ( NMC 111 ) + 2.3 Li OH \cdot {H}_{2} O + 2.3 {Ni ( {NO}_{3} )}_{2} \cdot 6 {H}_{2} O \to 3.3 {LiNi}_{0.8} {Mn}_{0.8} {Mn}_{0.1} {Co}_{0.1} {O}_{2} ( NMC 811 ) + 2.3 {NO}_{x} + 17.2 {H}_{2} O$$

A 10 mol % excess of LiOH·H₂O was used in order to overcome the issue of cation mixing (Ni²⁺/Li⁺) in the structure of Ni-rich materials. The material synthesized via eutectic synthesis (upcycled cathode active material) are hereinafter referred to as ES-NMC811. Once the second sintering step was completed, the powders were mixed again with the mortar and pestle. The powders were then sieved through a 50 μm mesh to ensure an appropriate, desired particle size.

The crystal structure of the ES-NMC811 was examined using an X-ray diffractometer (XRD, PANalytical X'PERT) operating at 45 kV and 40 mA and utilizing a Cu source (λ=1.54 Å). Diffraction patterns were recorded between 20 of 100 and 60° at room temperature with a 0.016° step size. The elemental composition of the powders was determined using inductively coupled plasma-optical emission spectroscopy (ICP-OES, Agilent Technologies 5110). The samples were digested in an aqua regia solution and then diluted in 2 wt. % HNO₃ for ICP measurement. The particle morphology was analyzed using a Zeiss-MERLIN™ field-emission scanning electron microscope (SEM). The structure of the particle surfaces was examined using a transmission electron microscope (TEM).

Composite cathodes were made by mixing ES-NMC811 with N-methyl-pyrrolidone (Sigma Aldrich) as the solvent, carbon black (CB, Denka Li-100) as the conductive additive, and polyvinylidene fluoride (PVDF, APV Engineered Coatings, 8.0 wt. % pre-dispersed in NMP) as the binder. The cathode slurries were made with 45 wt. % solids content, of which 90 wt. % was active material, 5 wt. % was CB, and 5 wt. % was PVDF, and were mixed in a high-energy ball mill (SPEX Sample Prep 8000M Mixer/Mill) for 30 minutes total. The cathode slurries were coated onto Al foil (15 μm thick, MTI Corp.) using a film applicator (Qualtech Products Industry) with a 200 μm wet gap. The coatings were dried overnight in a fume hood followed by 2 hours in a vacuum oven at 100° C. After drying, the active mass loading of the cathodes was approximately 6.3 mg·cm⁻². This led to an areal capacity of the cathodes of roughly 1.2 mAh·cm⁻², assuming a specific capacity of 190 mAh·g⁻¹ for ES-NMC811. To compare with the ES-NMC811 material, a composite cathode with commercially available NMC811 (Targray, d₅₀=13.8 μm) was made according to the same cathode recipe. Additionally, cells were constructed with the commercially available NMC111 for comparison with the precursor material. The commercially available NMC materials are hereinafter referred to as CA-NMC. All subsequent electrochemical testing was performed in an ESPEC battery testing chamber at 30° C.

Using the same materials above, half coin cells were built and subject to a cycle life protocol. Three formation cycles were performed between 3.0 and 4.3 V at +0.1C/−0.1C; these formation cycles were followed by 50 cycles at +0.5C/−0.5C between the same potential limits. After constant-current charging to 4.3 V, the cells were charged in a constant-voltage step for an additional 30 minutes or until the current dropped below C/20. After charge and discharge, the cells were rested for 15 minutes. Three cells of each material were cycled to ensure statistically significant results. For all tests utilizing multiple cells, the standard deviation of the capacity at a particular cycle number was used as the error bar.

In addition to the cycling tests, three coin cells were built for galvanostatic intermittent titration technique (GITT) analysis. GITT consists of two steps: (1) a step charging the cell for 1 hour to a specific state of charge (SOC), and (2) a step of relaxation for 2 hours. These steps (collectively called a loop) were repeated until the cell reached the upper cutoff potential, then were repeated as the cell was discharged to the lower cutoff potential, with the cell being discharged to a particular depth of discharge (DOD) at each step.

To determine if the synthesized, upcycled material was structurally and stoichiometrically NMC811, a number of material characterizations were performed. First, the stoichiometry of the ES-NMC811 sample was measured using ICP-OES. The exact formula of the ES-NMC811 was Li_{0.983}Ni_{0.779}Mn_{0.111}Co_{0.110}O₂, which is very similar to NMC811. This ICP-OES measurement is an average result. While it confirms the average composition, it is noted that it does not provide information on composition homogeneity.

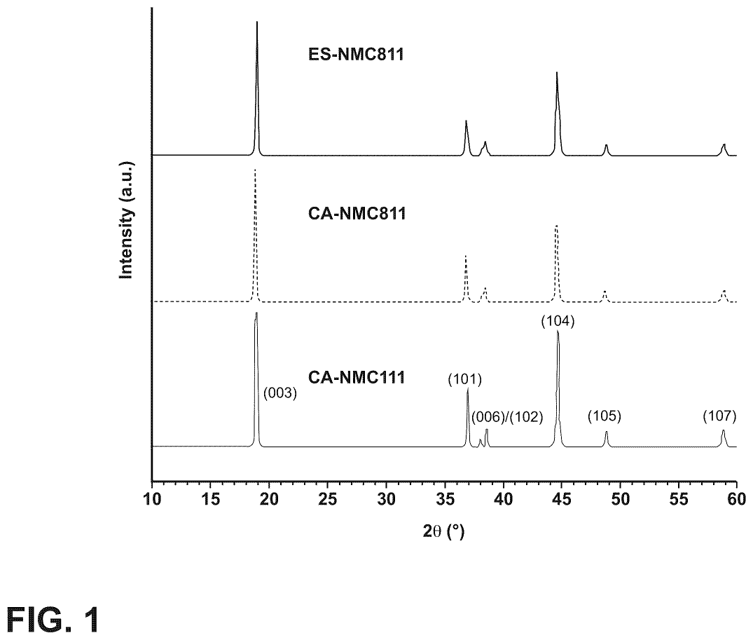

The diffraction patterns for the ES-NMC811, CA-NMC111, and CA-NMC811, are shown in FIG. 1. All three materials exhibited a layered oxide crystal structure with hexagonal α-NaFeO₂ structure and space group R3m. An important feature of the diffractograms is the intensity ratio between the (003) peak (I₀₀₃) and the (104) peak (I₁₀₄). The I₀₀₃/I₁₀₄ ratio is indicative of the degree of cation mixing in the active material; a I₀₀₃/I₁₀₄>1.2 suggests a low degree of cation mixing in the material. The intensity ratios for the CA-NMC811 and ES-NMC811 are 1.70 and 1.58, respectively, indicating excellent order in the structure. Additionally, the (006) and (102) peaks should be well-resolved in a material with good order in the crystal structure, which was also observed in both structures.

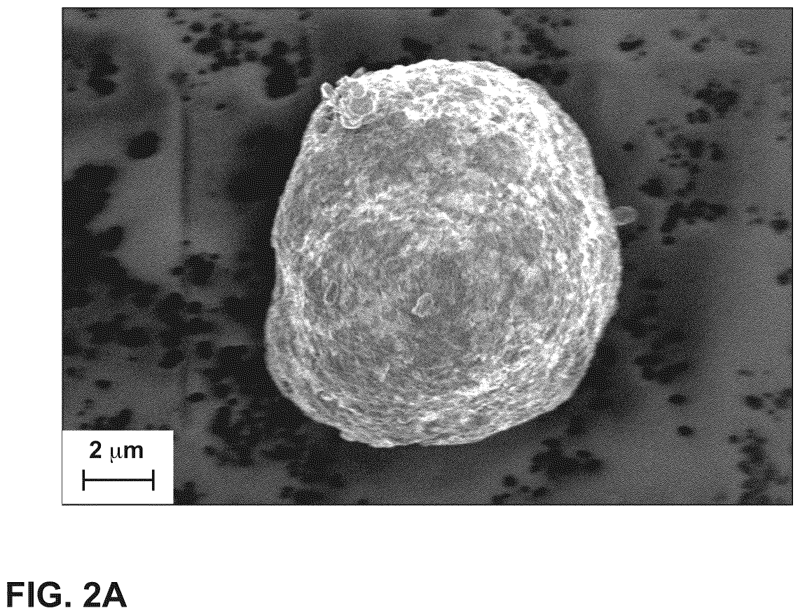

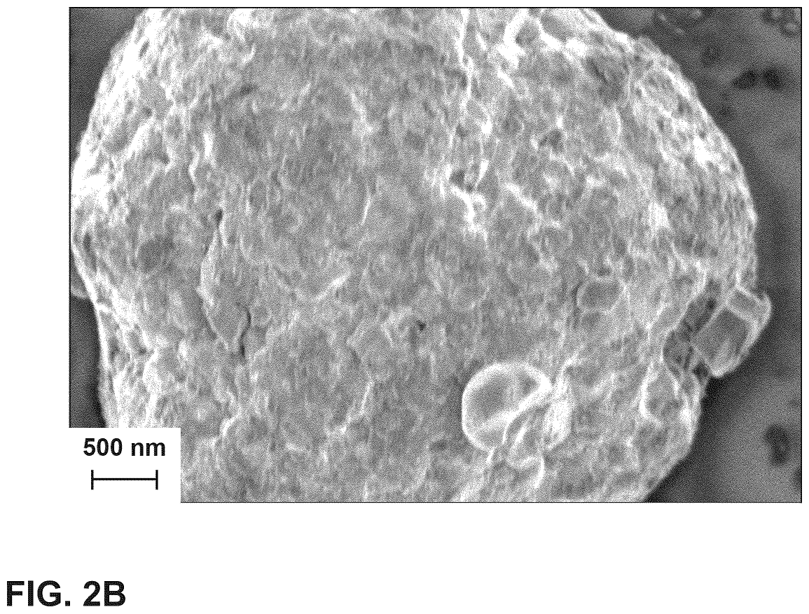

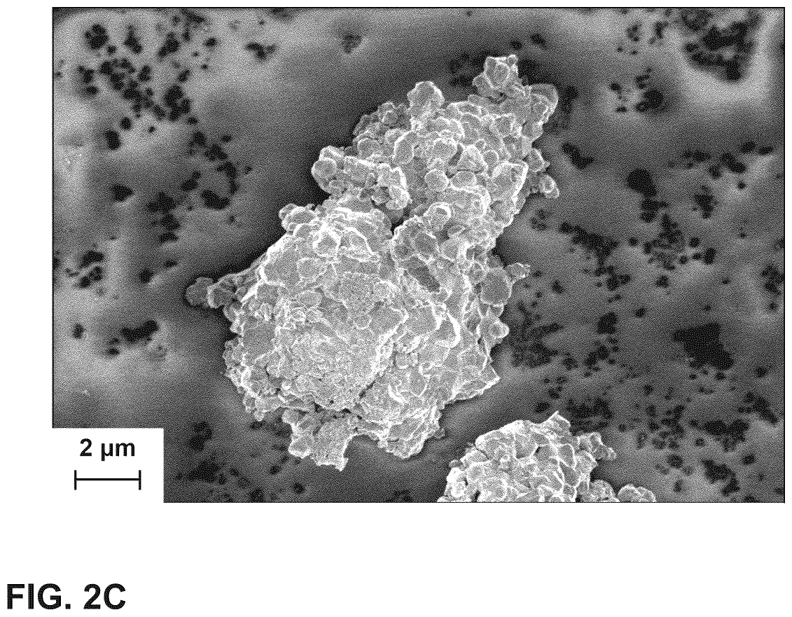

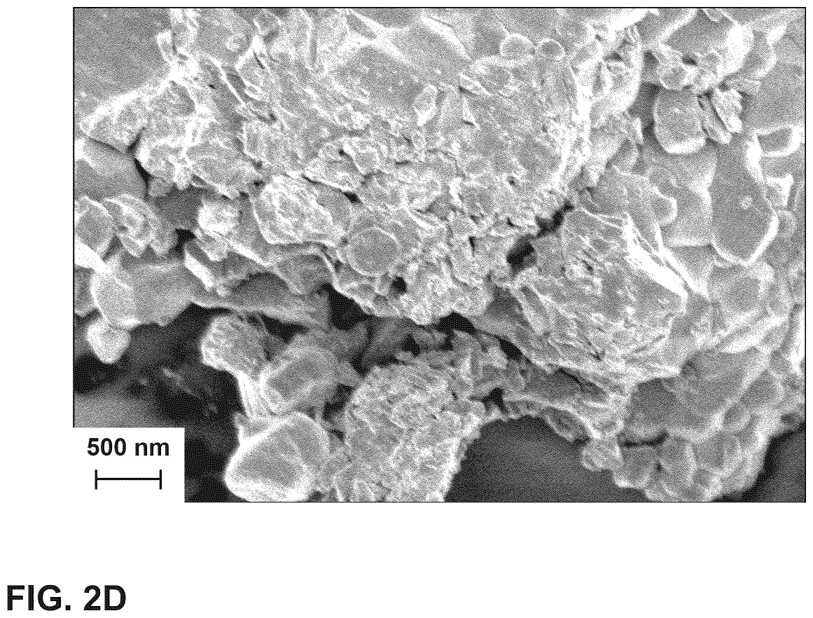

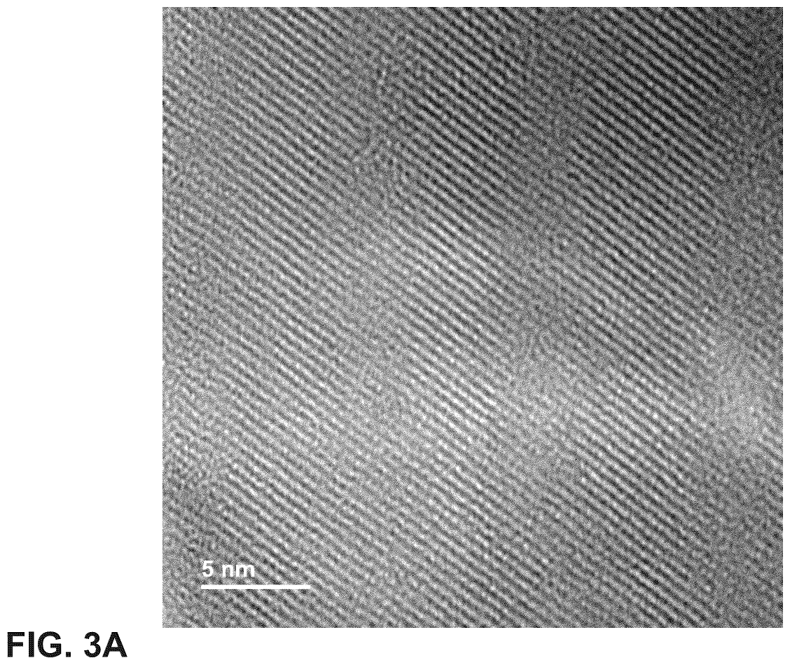

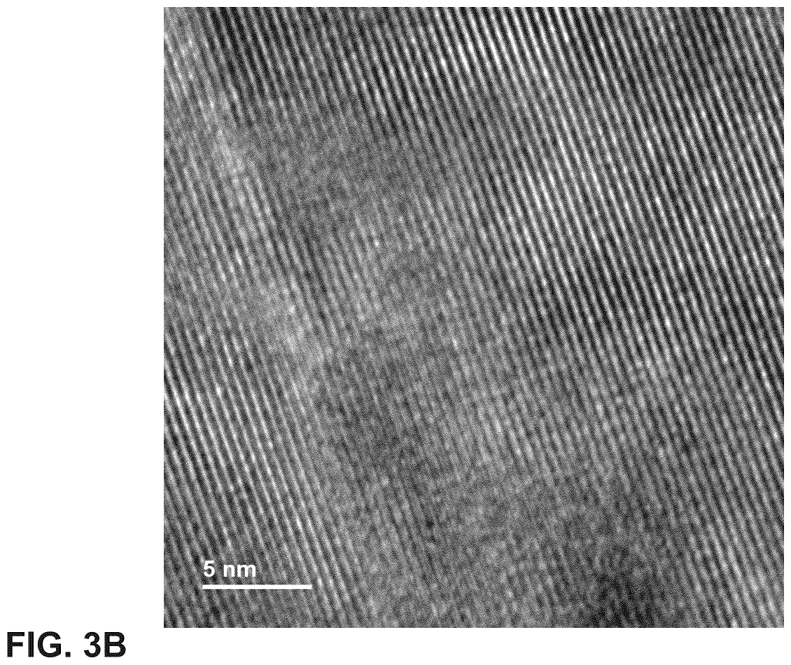

The materials were imaged using SEM as shown in FIGS. 2a-d and TEM as shown in FIGS. 3a-b. The CA-NMC111 secondary particles are roughly spherical, though the primary particles are somewhat indistinguishable (see FIGS. 2a-b). In the ES-NMC811 samples, the secondary particles are somewhat a polyhedral shape, though the primary particles are roughly spherical (see FIGS. 2c-d). Since particle morphology plays an important role in material performance, granulation may be required to achieve desirable particle morphology, size, and shape. Though not measured, the particle size distribution in the ES-NMC811 particles varied significantly according to the collected images, while the CA powders were generally within a tighter distribution. This is likely a product of the sophistication of the processes and equipment used in industrial cathode material production in comparison to the small-scale laboratory test synthesis of ES-NMC811 herein. The TEM images reveal good ordering at the surface of both the CA-NMC811 and ES-NMC811 material (see FIGS. 3a-b). This correlates well with the ICP-OES, XRD, and SEM data. However, the layer spacing between the two materials appears to be slightly different. The average layer spacing in the ES-NMC811 material is approximately 3.0 Å, while the average layer spacing in the CA-NMC811 material is shorter at 2.5 Å. Nevertheless, the material properties of the ES-NMC811 are quite similar to the CA-NMC811 material.

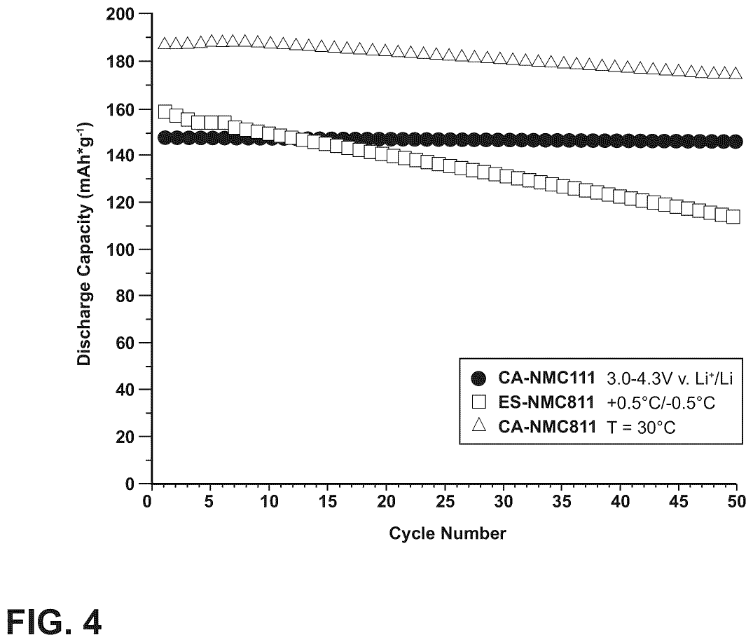

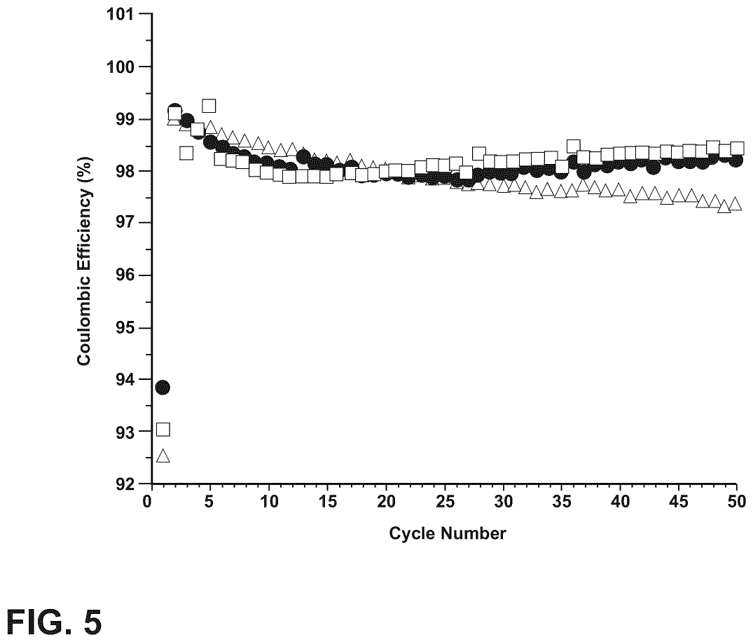

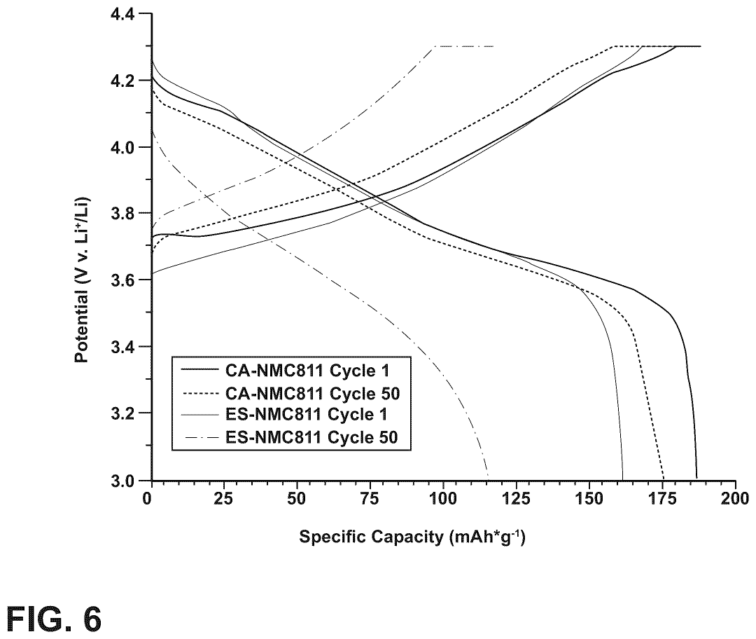

The cycle life of the ES-NMC811 was evaluated as shown in FIGS. 4-6, with the key for FIG. 4 also applying to FIG. 5. During the three formation cycles, (+0.1C/−0.1C, approximately +0.185 mA/−0.185 mA), the discharge capacity was 172.7, 171.7, and 170.6 mAh·g⁻¹, respectively. One would expect a discharge capacity of ≥190 mAh·g⁻¹ at such a low current density for NMC811. During cycling (+0.5C/−0.5C, approximately +0.923 mA/−0.923 mA), the initial discharge capacity was 158.2 mAh·g⁻¹ and dropped to below 80% of its initial capacity at the 35^{th} cycle (see FIG. 4). The point at which a cell reaches 80% of its initial capacity is commonly used to indicate a cell's EOL condition.

Comparing this data with the cycling performance of the precursor CA-NMC111 material, the capacity during the formation cycles was 158.5, 159.0, and 158.9 mAh·g⁻¹, respectively. As expected, the more Ni-rich ES-NMC811 material achieves significantly higher discharge capacity, since the Ni²⁺/Ni⁴⁺ redox reactions provide the most capacity within the selected potential window. During cycling, the initial capacity of the CA-NMC111 material was 147.4 mAh·g⁻¹, but faded to only 145.5 mAh·g⁻¹ (98.7% retention) by the 35^{th} cycle. Since the Ni-rich materials undergo additional phase transformations at higher potentials, causing irreversible structural rearrangement, it is unsurprising that the more Ni-deficient material would have a longer cell lifetime than the more Ni-rich material. Therefore, a comparison with CA-NMC811 is appropriate. During the three formation cycles, this cell achieved capacity of 196.3, 198.7, and 195.4 mAh·g⁻¹, which is about a 14% improvement over ES-NMC811. After 35 cycles, the CA-NMC811 cell delivered 179.1 mAh·g⁻¹, which was 95.8% of its first-cycle capacity. This is a decrease in capacity retention from CA-NMC111 but is still substantially better than ES-NMC811.

The Coulombic efficiency of CA-NMC111, ES-NMC811, and CA-NMC811 is relatively low (<99%) in nearly all 50 cycles due to the reactivity of the Li counter electrode (see FIG. 5). All cells have a relatively low first-cycle Coulombic efficiency, which is typical for the first cycle after formation when the current density is increased. Interestingly, the CA-NMC111 and ES-NMC811 follow similar trends in Coulombic efficiency. For cycles 2-10, the efficiency decreases to a value of 97.5%, then increases steadily to 98.5% by the 50^{th} cycle. Conversely, the Coulombic efficiency of the CA-NMC811 material decreases from its maximum value in the 2^{nd} cycle (˜99%) to a minimum of 97.3% in the 50^{th} cycle. The Coulombic efficiency is a measure of the side reactions in the cell, some of which involve the cathode active material and the electrolyte. Since the ES-NMC811 particles are larger than the CA-NMC811 particles, it could be that lower available surface area of the particles means that fewer reactions occur between the active material and the electrolyte. NMC811 becomes unstable at high UCV due to the presence of Ni⁴⁺ at the surface of the particle, which explains the discrepancy in Coulombic efficiency between CA-NMC111 and CA-NMC811.

For the half-cells, a GITT protocol was enacted after formation to determine the Li⁺ diffusion coefficient (D), which is defined as the square of the average diffusion length (L) divided by the time required for diffusion (t). Assuming spherical particles, the diffusion length is the average particle radius. The radius of 20 particles was measured using SEM and was determined to be 3.46 μm; this estimate was used as the average diffusion length. After a 1 hour charge in the GITT protocol, the potential decays rapidly before reaching a steady state; similarly, during the discharge steps, after a 1 hour discharge, the potential increases rapidly before reaching a steady state. The initial potential (E₀) and steady state potential (E_{∞}) can be related to the diffusion time according to the following Equation 2:

$$ln ( {E}_{0} - {E}_{∞} ) = ln ( A ) + \frac{8 t}{{π}^{2} τ}$$

By plotting the potential as a function of time during the rest period and removing the initial decay and steady-state data, a region where potential varies linearly with time can be identified. The slope of the equation fitting this data can be plugged into the D=L²/t equation mentioned above and can be used to calculate the diffusion coefficient according to the following Equation 3.

$$D = \frac{{L}^{2} {π}^{2} slope}{8}$$

The following Tables 1 and 2 summarize the SOC/DOD, slope, diffusion coefficient, and potential of each rest step for the charge and discharge, respectively.

TABLE 1
Data from the charge step of the GITT protocol

| SOC | | Diffusion | Potential (V vs. |
|---|---|---|---|
| (%) | Slope | Coefficient (cm² · s⁻¹) | Li⁺/Li) |
| 10 | 3.39 · 10⁻⁶ | 4.99 · 10⁻¹³ | 3.63 |
| 20 | 2.06 · 10⁻⁶ | 3.03 · 10⁻¹³ | 3.67 |
| 30 | 1.08 · 10⁻⁶ | 1.59 · 10⁻¹³ | 3.71 |
| 40 | 8.20 · 10⁻⁷ | 1.21 · 10⁻¹³ | 3.76 |
| 50 | 7.90 · 10⁻⁷ | 1.16 · 10⁻¹³ | 3.82 |
| 60 | 1.07 · 10⁻⁶ | 1.58 · 10⁻¹³ | 3.90 |
| 70 | 8.10 · 10⁻⁷ | 1.19 · 10⁻¹³ | 3.99 |
| 80 | 1.88 · 10⁻⁶ | 2.77 · 10⁻¹³ | 4.09 |
| 90 | 9.70 · 10⁻⁷ | 1.43 · 10⁻¹³ | 4.18 |
| 100 | 3.52 · 10⁻⁶ | 5.18 · 10⁻¹³ | 4.30 |

TABLE 2
Data from the discharge step of the GITT protocol

| DOD | | Diffusion | Potential (V vs. |
|---|---|---|---|
| (%) | Slope | Coefficient (cm² · s⁻¹) | Li⁺/Li) |
| 90 | 8.60 · 10⁻⁷ | 1.27 · 10⁻¹³ | 4.16 |
| 80 | 1.00 · 10⁻⁶ | 1.47 · 10⁻¹³ | 4.05 |
| 70 | 1.22 · 10⁻⁶ | 1.80 · 10⁻¹³ | 3.95 |
| 60 | 1.02 · 10⁻⁶ | 1.50 · 10⁻¹³ | 3.86 |
| 50 | 1.15 · 10⁻⁶ | 1.69 · 10⁻¹³ | 3.78 |
| 40 | 1.19 · 10⁻⁶ | 1.75 · 10⁻¹³ | 3.73 |
| 30 | 1.40 · 10⁻⁶ | 2.06 · 10⁻¹³ | 3.67 |
| 20 | 2.24 · 10⁻⁶ | 3.30 · 10⁻¹³ | 3.61 |
| 10 | 5.15 · 10⁻⁶ | 7.58 · 10⁻¹³ | 3.44 |
| 0 | 8.05 · 10⁻⁶ | 1.19 · 10⁻¹² | 3.00 |

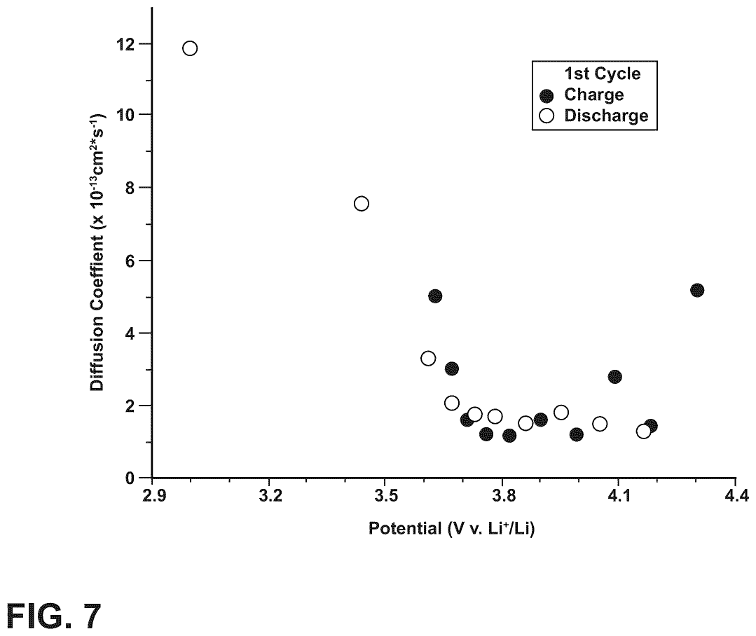

The diffusion coefficient as a function of potential for the first charge and discharge after formation is shown in FIG. 7. Between 3.6 and 4.2 V vs. Li^{±}/Li, the diffusion coefficient for ES-NMC811 is approximately between 1-2·10⁻¹³ cm²·s⁻¹, which is several orders of magnitude lower than what has been reported for NMC materials.

This example demonstrates the present method of upcycling cathode materials via room temperature eutectic synthesis. Compared to other methods such as solid-state sintering, hydrothermal, and deep eutectic solvents, the present eutectic method uses common, low-cost precursors and forms a eutectic mixture at low temperature. This allows for low temperature annealing. The present method also generates a high purity and homogeneous material, which is very scalable. The synthesized material had minimal cation mixing and the preferred stoichiometry. The cycle life of the ES-NMC811 material, however, was less than that of both the precursor NMC111 material and the CA-NMC811, and the Li diffusion coefficient was lower in the ES-NMC811 material.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of upcycling cathode active materials, the method comprising:
mixing two or more precursor materials at ambient temperature to form a first eutectic mixture;
mixing a cathode active material with the first eutectic mixture to form a second eutectic mixture;
subjecting the second eutectic mixture to a two-step calcination process, wherein the two-step calcination process includes first calcining the second eutectic mixture at a first temperature for a first period of time to obtain an intermediate material and second calcining the intermediate material at a second temperature for a second period of time to obtain an upcycled cathode active material, wherein the second temperature is higher than the first temperature, and wherein the upcycled cathode active material has a composition that is different than a composition of the cathode active material.

2. The method of claim 1, wherein the first temperature is in a range of 300 to 400° C.

3. The method of claim 1, wherein the second temperature is in a range of 700 to 1000° C.

4. The method of claim 1, wherein the first period of time is at least 4 hours.

5. The method of claim 1, wherein the second period of time is at least 8 hours.

6. The method of claim 1, wherein the two-step calcination process further comprises an intermediate step of muddling the second eutectic mixture after the first calcining and before the second calcining.

7. The method of claim 1, wherein the first calcining is performed in ambient air.

8. The method of claim 1, wherein the second calcining is performed in the presence of an oxygen (02) stream.

9. The method of claim 1, wherein the precursor materials include lithium hydroxide and nickel nitrate.

10. The method of claim 1, further comprising the step of sieving the upcycled cathode active material after the second calcining.

11. The method of claim 1, wherein the cathode active material is obtained from one of or both of a spent battery and cathode scrap from a cathode manufacturing process.

12. The method of claim 1, wherein the cathode active material comprises a lithium-bearing metal oxide.

13. The method of claim 1, wherein the upcycled cathode active material has a nickel content that is greater than a nickel content of the cathode active material.

14. The method of claim 1, wherein the upcycled cathode active material: (i) comprises substantially the same morphology as the cathode active material; (ii) is directly reusable in the preparation of a new composite electrode; or (iii) both (i) and (ii).

15. The method of claim 1, further comprising preparing a new composite electrode using the upcycled cathode active material.

16. The method of claim 15, further comprising preparing a new lithium-ion battery using the new composite electrode.

17. A cathode active material formed by the method of claim 1.
